(19) United States
(12) Patent Application Publication
(10) Pub. No.: US 2016/0104265 A1
(43) Pub. Date: Apr. 14, 2016

(54) METHOD FOR INTEGRATION OF CALCULATIONS HAVING A VARIABLE RUNNING TIME INTO A TIME-CONTROLLED ARCHITECTURE

(71) Applicant: FTS COMPUTERTECHNIK GMBH, Wien (AT)

(72) Inventors: Stefan POLEDNA, Klosterneuburg (AT); Martin GLüCK, Spannberg (AT)

(21) Appl. No.: 14/892,610

(22) PCT Filed: May 20, 2014
(86) PCT No.: PCT/AT2014/050120

§ 371 Date: Nov. 20, 2015

(30) Foreign Application Priority Data
May 21, 2013 (AT) A 50341/2013

(51) Int. Cl. G06T 3/00; G08G 1/16

(52) U.S. Cl. CPC G06T 3/0056; G08G 1/165; G08G 1/166

(57) ABSTRACT

The invention relates to a method for the integration of calculations having a variable running time into a distributed, time-controlled, real-time computer architecture, which real-time computer architecture consists of a plurality of computer nodes, wherein a global time having known precision is available to the computer nodes, wherein at least a portion of the computer nodes is equipped with sensor systems, in particular different sensor systems for observing the environment, and wherein the computer nodes exchange messages via a communication system, wherein at the start of each cyclical frame Fᵢ having the duration d, the computer nodes acquire raw input data by means of a sensor system, wherein the start times of frame Fᵢ are deduced from the progress of the global time, and wherein the pre-processing of the raw input data is carried out by means of algorithms, the running times of which depend upon the input data, and wherein the value of the ageing index AI=0 is assigned to a pre-processing result which is produced within the frame Fᵢ at the start of which the input data were acquired, and wherein the value of the ageing index AI=1 is assigned to a pre-processing result which is produced within the frame following the frame in which the input data were acquired, and wherein the value AI=n is assigned to a pre-processing result which is produced in the n-th frame after the data acquisition, and wherein the ageing indices of the pre-processing results are taken into consideration in the computer nodes which carry out the fusion of the pre-processing results of the sensor systems.

The invention relates to a method for the integration of calculations having a variable running time into a distributed, time-controlled, real-time computer architecture, which real-time computer architecture consists of a plurality of computer nodes, wherein a global time having known precision is available to the computer nodes, wherein at least a portion of the computer nodes is equipped with sensor systems, in particular different sensor systems for observing the environment, and wherein the computer nodes exchange messages via a communication system.

In many technical processes, which are carried out by a distributed computer system, the results of various sensor systems, e.g., imaging sensors, such as optical cameras, laser sensors or radar sensors, must be integrated by means of sensor fusion, in order to make it possible to build a three-dimensional data structure, which describes the environment, in a computer. One example of such a process is the observation of the environment of a vehicle in order to make it possible to detect an obstacle and avoid an accident.

In processing the data of an imaging sensor, a distinction is made between two processing phases, i.e., pre-processing or perception and perception or cognition. Within the scope of pre-processing, the raw input data, the bitmaps, are analyzed by the sensors in order to determine the position of relevant structures, e.g., lines, angles between lines, shadows, etc. Pre-processing is carried out in a pre-processing process assigned to the sensor. In the following perception phase, the results of the pre-processing of the various sensors are fused in order to enable the detection and localization of objects.

In a time-controlled, real-time system, all computer nodes and sensors have access to a global time having a known precision. The processing sequence is carried out in discrete cyclic intervals having a constant duration, the frames, the start of which is synchronized via the global time. At the beginning of a frame, the data are detected simultaneously by all sensors. The duration of a frame is selected in such a way that, in the normal case, the pre-processing of the sensor data is completed before the end of the frame at the start of which the input data were collected. At the beginning of the following frame, when the pre-processing results of all sensors are available, the perception phase begins, in which the fusion of the pre-processing results is carried out in order to detect the structure and position of relevant objects. When the environment is cyclically observed, the velocity vectors v of moving objects in the environment can be determined from a sequence of observations (frames).

The running time of an algorithm carried out in a computer, which algorithm carries out the pre-processing of the raw input data, normally depends upon the data acquired by the sensor. If a plurality of different imaging sensors then observe the environment at the same time, the pre-processing results related to this observation can be completed at different points in time.

A problem addressed by the present invention is that of enabling the results of various sensors, the pre-processing of which takes different lengths of time, to be integrated in a distributed, time-controlled, real-time system within the scope of sensor fusion.

This problem is solved using an initially mentioned method in that, according to the invention, at the start of each cyclical frame Fᵢ having the duration d, the computer nodes acquire raw input data by means of a sensor system, wherein the start times of frame Fᵢ are deduced from the progress of the global time, and wherein the pre-processing of the raw input data is carried out by means of algorithms, the running times of which depend upon the input data, and wherein the value of the ageing index AI=0 is assigned to a pre-processing result which is produced within the frame Fᵢ at the start of which the input data were acquired, and wherein the value of the ageing index AI=1 is assigned to a pre-processing result which is produced within the frame following the frame in which the input data were acquired, and wherein the value AI=n is assigned to a pre-processing result which is produced in the n-th frame after the data acquisition, and wherein the ageing indices of the pre-processing results are taken into consideration in the computer nodes which carry out the fusion of the pre-processing results of the sensor systems.

Advantageous embodiments of the method according to the invention, which can be implemented individually or in any combination, are described in the following:
in the fusion of the pre-processing results, the weighting of a pre-processing result is determined in such a way that a pre-processing result having AI=0 receives the highest weighting and the weighting of pre-processing results having AI>0 is that much smaller, the greater the value AI is;
in the fusion of a pre-processing result having AI>0, the position of a dynamic object contained in this pre-processing result, which object moves with a velocity vector v, is corrected by the value v.AI.d, wherein d indicates the duration of a frame;
the fusion of the pre-processing results does not take place until after the end of the frame during which all pre-processing results of the data, which were detected at the same time, are available;
a computer node, which has not yet concluded the pre-processing at the end of the l-th frame after the data acquisition, carries out a reset of the computer node;
a pre-processing process, which has not yet concluded the pre-processing at the end of the l-th frame after the data acquisition, is restarted;
a computer node, which has carried out a reset, sends a diagnostic message to a diagnostic computer immediately after the restart;
a monitor process in a computer node sends a frame control message to increase the frame duration to computer nodes if an a priori determined percentage P of the pre-processing results has an ageing index AI≧1;

the TTEthernet protocol is used to transmit messages between the node computers.

It is therefore possible that the pre-processing in a sensor takes longer than the duration of a frame. If this case occurs, a distinction must be made, according to the invention, between the following cases:
a) Normal case: all the pre-processing results are available before the end of the frame at the start of which the data were detected.
b) Rapid reaction: One or more of the sensors are not yet ready at the end of the frame at the start of which the data were detected. The sensor fusion is carried out at the end of the current frame in a timely manner using older pre-processing data of the slow sensors, i.e., data from an earlier observation. If inconsistencies occur (e.g., observation of moving objects or movement of the sensors), the weighting of the older pre-processing data is reduced. The reduction of the weighting is that much greater, the further back the observations are.
c) Rapid reaction with the correction of moving objects: If a rapid reaction is required and the approximate velocity vector v of a moving object is already known from previous observations, the current position of the object observed in the past can be corrected by means of a correction of the previous position, which results from the velocity of the object and the age of the original observation.
d) Consistent reaction: If the time consistency of the observations is more important than the reaction speed of the computer system, the sensor fusion waits for the beginning of the first frame at which all pre-processing results are available.

The decision regarding which of the above-described strategies to pursue in the particular case depends upon the specific problem definition, which specifies how to solve the inherent conflict of velocity versus consistency. A method which addresses the statement of the problem described here was not found in the researched patent literature [1-3].

The present invention discloses a method describing how the pre-processing results of various imaging sensor systems can be integrated within the scope of sensor fusion in a distributed, cyclically operating computer system. Since the duration of the calculation of a pre-processing result depends upon the acquired sensor data, the case can occur in which the pre-processing results of the various sensors are completed at different times, even though the data were acquired synchronously. An innovative method is presented, which describes how to handle the time inconsistency of the pre-processing results of the various sensors within the scope of sensor fusion. From the perspective of the application, it must be decided whether a rapid reaction of the system or the time consistency of the data in the given application is of greater significance.

The invention is explained in greater detail in the following by way of example with reference to the drawing. In this drawing

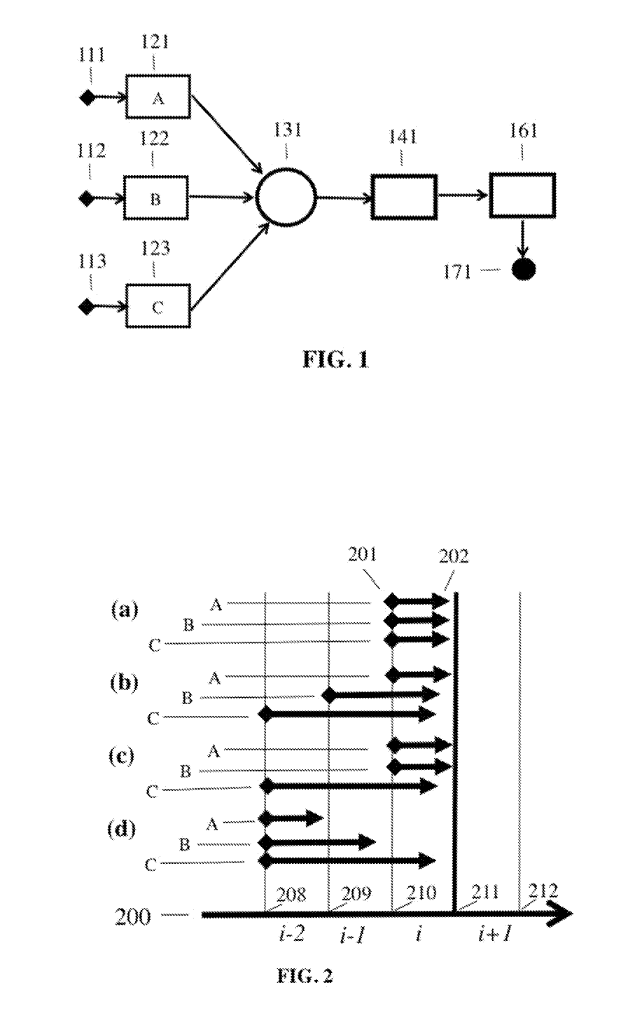

FIG. 1 shows the structure of a distributed computer system, and

FIG. 2 shows the time sequence of data acquisition and sensor fusion.

The following specific example is one of the many possible embodiments of the new method.

FIG. 1 shows a structure diagram of a distributed cyclic real-time system. The three sensors 111 (e.g., a camera), 112 (e.g., a radar sensor), and 113 (e.g., a laser sensor) are periodically read out by a process A on computer node 121, by a process B on computer node 122, and by a processs C on computer node 123. In the normal case, the times of the read-out take place at the beginning of a frame Fᵢ and are synchronized via the global time, which all computer nodes can access, and therefore the data acquisition is carried out by the three sensors (sensor systems) quasi simultaneously within the precision of the sparse global time ([4], p. 64). The duration d of a frame is specified a priori at the beginning and can be changed by means of a frame control message, which is generated by a monitor process in the computer node 141. The sensor data are pre-processed in the computer nodes 121, 122, and 123. In the normal case, the pre-processing results of the computer nodes 121, 122, and 123 are available before the end of the running frame in three time-controlled state messages ([4], p. 91) in the output buffers of the computer nodes 121, 122, and 123. At the beginning of the following frame, the three state messages with the pre-processing results are sent to the sensor fusion component 141 via a time-controlled switch 131. The sensor fusion component 141 carries out the sensor fusion, calculates the setpoint values for the actuators, and transfers these setpoint values, in a time-controlled message, to a computer node 161 which controls actuators 171.

The time-controlled switch 131 can use the standardized TTEthernet protocol [5] to transmit the state messages between the computer nodes 121, 122, and 123 and the computer node 141.

It is possible that one or more of the pre-processing calculations running in the computer nodes 121, 122, and 123 are not completed within the running frame. Such a special case is based on the fact that the running times of the algorithms for pre-processing the raw input data depend upon the structure of the acquired input data and, in exceptional cases, the maximum running time of a calculation can be substantially longer than the average running time used to define the frame duration.

FIG. 2 shows the time sequence of the possible cases of the calculation processes of the pre-processing. The progress of the real time is indicated in FIG. 2 by the abscissa 200. Frame i−2 begins at time 208 and ends at the beginning of the frame i−1 at the time 209. At the time 210, frame i−1 ends and frame i begins. At the time 211, the time of the beginning of the sensor fusion, frame i ends and frame i+1 begins. In frame i+1, sensor fusion takes place and lasts until the time 212. The arrows in FIG. 2 indicate the running time of the pre-processing processes. The center of the square 201 indicates when the data are acquired and a processing process begins. The end of the arrow 202 indicates when a processing process is done. Three processing processes are depicted in FIG. 2. Process A is carried out on the computer node 121, process B is carried out on the computer node 122 and process C is carried out on the computer node 123.

An ageing index AI is assigned to each pre-processing result by a computer node, preferably the middleware of a computer node, which ageing index indicates how old the input data are, on the basis of which the pre-processing result was calculated. If the result is presented before the end of the frame at the beginning of which the input data were acquired, the value AI=0 is assigned to the pre-processing result; if the result is delayed by one frame, the value AI=1 is assigned and if the result is delayed by two frames, the value AI=2 is assigned. If a processing result is delayed by n frames, the corresponding AI value is assigned the value AI=n.

In the normal case, which is case (a) in FIG. 2, the raw input data are acquired at the beginning of the frame i, i.e., at the time 210 and, at the time 211, is forwarded to the sensor fusion component 141. In this case, the value AI=0 is assigned to all pre-processing results.

If a computer node is not finished with the pre-processing of the acquired data at the end of the frame at the beginning of which the data were acquired and a new state message with the pre-processing results has not yet formed, the time-controlled state message of the preceding frame remains unchanged in the output buffer of the computer node. The time-controlled communication system will therefore transmit the state message of the preceding frame once more at the beginning of the next frame.

If a computer node is not finished with the pre-processing of the acquired data at the end of the frame at the beginning of which the data were acquired, the computer node will not acquire any new data at the beginning of the next frame.

In case (b) in FIG. 2, the processing result is delayed by one frame by the process B on computer node 122—AI_{B} is assigned the value AI_{B}=1. The processing result of process C on computer node 123 is delayed by two frames—AI_{c} is assigned the value AI_{C}=2. The processing result of process A on computer node 121 is not delayed and is therefore assigned the value AI_{A}=0. Within the scope of sensor fusion, the processing result of process A is assigned the highest weighting. The processing results of process B and process C will be incorporated into the sensor fusion result with correspondingly less weighting, due to the higher AI_{B} and AI_{C}.

In case (c) in FIG. 2, the processing results of processes A and B are not delayed. The values AI_{A}=0 and AI_{B}=0 are therefore assigned. The processing result of process C on computer node 123 is delayed by two frames, and therefore AI_{C} has the value AI_{C}=2. If it is known, for example via the evaluation of preceding frames, that there is a moving object in the observed environment, which can change its location with the velocity vector v, the location of this object can be corrected, in the first approximation, by the value v.AI.d, wherein d indicates the duration of a frame. By means of this correction, the position of the object is moved close to the location that the object had approximately assumed at the time 210, and the age of the data are therefore compensated. Timely processing results, i.e., processing results having the value AI=0, are not affected by this correction.

In case (d) in FIG. 2, the sensor fusion is delayed until the slowest process, which is process C in the specific picture, has provided its pre-processing result. The time consistency of the input data is therefore given, since all observations were carried out at the same time 208 and fusion was started at the same time 211. Since the data were first fused at the time 211, the results of the data fusion are not available until the time 212. The improved consistency of the data is contrasted with a delayed reaction of the system.

Which of the proposed strategies (b), (c) or (d) is selected to handle delayed pre-processing results depends upon the given application scenario. If, for example, the frame duration is 10 msec and a vehicle travels at a speed of 40 m/sec (i.e., 144 km/h), the braking distance is extended by 40 cm with strategy (d) as compared to strategy (b). When parking at a speed of 1 m/sec (3.6 km/h), where accuracy is particularly important, the extension of the braking distance by 1 cm is not particularly significant.

If one of the computer nodes 121, 122, and 123 still has not provided a result at the end of the l-th frame (l ist an a priori defined parameter, where l>1) after the data acquisition, the pre-processing process in this computer is aborted by an active monitoring process in the computer node and either the process is restarted or a reset of the computer node, which has carried out the pre-processing process, is carried out. A diagnostic message must be sent to a diagnostic computer immediately after the restart of a computer node following the reset.

If the aforementioned monitor process in the computer node 141 determines that an a priori defined percentage P of the processing results has an ageing index of AI≧1, the monitor process in the computer node 141 can send a frame control message to the computer nodes 121, 122, and 123 in order to increase, e.g., double, the frame duration. The data consistency with respect to time is therefore improved, but at the expense of the reaction time.

The proposed method according to the invention solves the problem of the time inconsistency of sensor data, which are acquired by various sensors and are pre-processed by the assigned computer nodes. It therefore has great economic significance.

The present invention discloses a method describing how the pre-processing results of various imaging sensor systems can be integrated within the scope of sensor fusion in a distributed, cyclically operating computer system. Since the duration of the calculation of a pre-processing result depends upon the acquired sensor data, the case can occur in which the pre-processing results of the various sensors are completed at different times, even though the data were acquired synchronously. An innovative method is presented, which describes how to handle time inconsistency of the pre-processing results of the various sensors within the scope of sensor fusion. From the perspective of the application, it must be decided whether a rapid reaction of the system or the time consistency of the data in the given application is of greater significance.

### Literature Citations

[1] U.S. Pat. No. 7,283,904. Benjamin, et al. Multi-Sensor Fusion. Granted Oct. 16, 2007.
[2] U.S. Pat. No. 8,245,239. Garyali, et al. Deterministic Run-Time Execution Environment and Method. Granted Aug. 14, 2012
[3] U.S. Pat. No. 8,090,552. Henry, et al. Sensor Fusion using Self-Evaluating Process Sensors. Granted Jan. 3, 2012.
[4] Kopetz, H. Real-Time Systems, Design Principles for Distributed Embedded Applications. Springer Verlag. 2011.
[5] SAE Standard AS6802 von TT Ethernet. URL: http://standards.sae.org/as6802

1. A method for the integration of calculations having a variable running time into a distributed, time-controlled, real-time computer architecture, which real-time computer architecture consists of a plurality of computer nodes, wherein a global time having known precision is available to the computer nodes, wherein at least a portion of the computer nodes is equipped with sensor systems, in particular different sensor systems for observing the environment, and wherein the computer nodes exchange messages via a communication system, the method comprising:
collecting, by the computer nodes, at the start of each cyclical frame Fi having the duration d, raw input data by means of a sensor system, wherein the start times of frame Fi are deduced from the progress of the global time; and
pre-processing the raw input data by means of algorithms, the running times of which depend upon the input data, and wherein the value of the ageing index AI=0 is assigned to a pre-processing result which is produced within the frame Fi at the start of which the input data were collected, and wherein the value of the ageing index AI=1 is assigned to a pre-processing result which is produced within the frame following the frame in which the input data were collected, and wherein the value AI=n is assigned to a pre-processing result which is produced in the n-th frame after the data acquisition, and wherein the ageing indices of the pre-processing results are taken into consideration in the computer nodes which carry out the fusion of the pre-processing results of the sensor systems.

2. The method of claim 1, wherein, in the fusion of the pre-processing results, the weighting of a pre-processing result is determined in such a way that a pre-processing result having AI=0 receives the highest weighting and the weighting of pre-processing results having AI>0 is that much smaller, the greater the value AI is.

3. The method of claim 1, wherein, in the fusion of a pre-processing result having AI>0, the position of a dynamic object contained in this pre-processing result, which object moves with a velocity vector v, is corrected by the value v.AI.d, wherein d indicates the duration of a frame.

4. The method of claim 1, wherein the fusion of the pre-processing results does not take place until after the end of the frame during which all pre-processing results of the data, which were detected at the same time, are available.

5. The method of claim 1, wherein a computer node, which has not yet concluded the pre-processing at the end of the l-th frame after the data acquisition, carries out a reset of the computer node.

6. The method of claim 1, wherein a pre-processing process, which has not yet concluded the pre-processing at the end of the l-th frame after the data acquisition, is restarted.

7. The method of claim 1, wherein a computer node, which has carried out a reset, sends a diagnostic message to a diagnostic computer immediately after the restart.

8. The method of claim 1, wherein a monitor process in a computer node (141) sends a frame control message to increase the frame duration to computer nodes (121, 122, 123) if an a priori determined percentage P of the pre-processing results has an ageing index AI>1.

9. The method of claim 1, wherein the TTEthernet protocol is used to transmit messages between the node computers.
